(19) United States
(12) Patent Application Publication
(10) Pub. No.: US 2022/0070322 A1
(43) Pub. Date: Mar. 3, 2022

(54) DOCUMENT READING DEVICE, IMAGE OUTPUT APPARATUS EQUIPPED WITH DOCUMENT READING DEVICE, RECORDING MEDIUM STORING CONTROL PROGRAM FOR DOCUMENT READING DEVICE, AND CONTROL METHOD FOR DOCUMENT READING DEVICE

(71) Applicant: SHARP KABUSHIKI KAISHA, Osaka (JP)

(72) Inventor: KAZUMA OGAWA, Osaka (JP)

(21) Appl. No.: 17/380,747

(22) Filed: Jul. 20, 2021

(30) Foreign Application Priority Data
Aug. 25, 2020 (JP) 2020-141839

(51) Int. Cl. H04N 1/00; H04N 1/387

(52) U.S. Cl. CPC H04N 1/00721; H04N 1/00013; H04N 1/0057; H04N 2201/0094; H04N 1/3877; H04N 1/0044; H04N 1/00777

(57) ABSTRACT

A multifunction peripheral includes an automatic document feeder allowing a document to be conveyed one sheet at a time along a document conveyance path. The document passes through an image reading position midway through conveyance and an image of the document is thereby read. In addition, the angle of tilt of the document is detected on the document conveyance path. If the absolute value of the angle of tilt is less than a first threshold, for instance, tilt correction is not conducted. If the absolute value of the angle of tilt is not less than the first threshold but is less than a second threshold, tilt correction is conducted by image processing. If the absolute value of the angle of tilt is not less than the second threshold, the conveyance of the document is stopped.

### BACKGROUND OF THE INVENTION

### Field of the Invention

The present invention relates to a document reading device, an image output apparatus equipped with the document reading device, a recording medium storing a control program for the document reading device, and a control method for the document reading device. In particular, the present invention relates to a document reading device including a conveyer that conveys a document in sheet form along a conveyance path and an image reader that reads an image of the document passing through an image reading position on the conveyance path midway through conveyance by the conveyer, an image output apparatus equipped with the document reading device, a recording medium storing a control program for the document reading device, and a control method for the document reading device.

### Description of the Background Art

An example of such a technology as above is disclosed in JP 2015-162724 A. According to the technology disclosed in JP 2015-162724 A, a posture of a document being conveyed on a conveyance path is detected. If the detected posture of the document is a posture with a tilt of a value not less than a specified threshold, the tilt of the document is corrected and the tilt correction is performed by, so to speak, a mechanical mechanism. If the tilt of the document is of a value less than the threshold, a tilt of a read image is corrected based on a tilt amount calculated from the read image, that is to say, the tilt correction is performed by image processing.

In other words, according to the technology disclosed in JP 2015-162724 A, tilt correction is indispensably performed irrespective of whether the tilt of the document is less than the threshold, and tilt correction is performed by image processing especially when the tilt of the document is less than the threshold. The tilt correction by image processing imposes a heavy burden on a document reading device and deteriorates the performance of the document reading device. On the other hand, a slight tilt of a document is acceptable depending on circumstances, that is to say, may not require tilt correction. Besides, an excessive tilt of a document may cause another sort of inconvenience, that is to say, may cause the document to get caught in a lateral edge portion of a conveyance path and broken, and it is also very important to avoid such inconvenience.

An object of the present invention is to provide a new technology making it possible, in a document reading device, an image output apparatus equipped with the document reading device, a recording medium storing a control program for the document reading device, and a control method for the document reading device, to suppress the deterioration in performance of the document reading device and appropriately cope with inconveniences due to the conveyance of a tilting document.

### SUMMARY OF THE INVENTION

In order to achieve the above object, the present invention has a first aspect relating to a document reading device, a second aspect relating to an image output apparatus equipped with the document reading device, a third aspect relating to a recording medium storing a control program for the document reading device, and a fourth aspect relating to a control method for the document reading device.

A document reading device according to the first aspect of the present invention includes a conveyer, an image reader, a degree of tilt detector, a tilt corrector, a correction controller, and a stopper. The conveyer conveys a document in sheet form along a conveyance path. The image reader reads an image of the document passing through an image reading position on the conveyance path midway through conveyance by the conveyer. The degree of tilt detector detects a degree of tilt of the document with respect to a basic posture upstream from the image reading position in a conveyance direction of the document. The tilt corrector performs, based on a result of detection by the degree of tilt detector, a tilt correcting process for correcting a tilt of a read image read by the image reader. The correction controller makes the tilt correcting process to be performed by the tilt corrector unperformed if the result of detection by the degree of tilt detector is less than a first threshold. The correction controller causes the tilt corrector to perform the tilt correcting process if the result of detection by the degree of tilt detector is not less than the first threshold but is less than a second threshold larger than the first threshold. The stopper stops conveyance of the document by the conveyer if the result of detection by the degree of tilt detector is not less than the second threshold.

The document reading device according to the first aspect may further include an inquirer and an answer acceptor. The inquirer inquires of a user whether the user wishes the tilt correcting process performed, if the result of detection by the degree of tilt detector is not less than the first threshold but is less than the second threshold. The answer acceptor accepts an answer offered by the user to an inquiry made by the inquirer. In that case, the correction controller may cause the tilt corrector to perform the tilt correcting process, if the result of detection by the degree of tilt detector is not less than the first threshold but is less than the second threshold and, in addition to that, the answer offered by the user and accepted by the answer acceptor indicates that the user wishes the tilt correcting process performed.

The document reading device according to the first aspect may further include a preview image display. The preview image display displays a preview image based on the read image read by the image reader when the inquirer inquires of the user.

In the first aspect of the present invention, it is desirable that the first threshold is optionally changeable. In contrast, the second threshold is desirably unchanged.

An image output apparatus according to the second aspect of the present invention includes the document reading device according to the first aspect and an image outputting device. The image outputting device outputs an image based on the read image read by the image reader.

A non-transitory computer readable recording medium according to the third aspect of the present invention stores a control program for a document reading device, the control program causing a computer of the document reading device to implement a degree of tilt detecting procedure, a tilt correcting procedure, a correction controlling procedure, and a stopping procedure. The document reading device includes a conveyer and an image reader. The conveyer conveys a document in sheet form along a conveyance path. The image reader reads an image of the document passing through an image reading position on the conveyance path midway through conveyance by the conveyer. Under such conditions, in the degree of tilt detecting procedure, a degree of tilt of the document with respect to a basic posture is detected upstream from the image reading position in a conveyance direction of the document. In the tilt correcting procedure, a tilt correcting process for correcting a tilt of a read image read by the image reader is performed based on a result of detection by the degree of tilt detecting procedure. In the correction controlling procedure, the tilt correcting process in the tilt correcting procedure is made unperformed if the result of detection by the degree of tilt detecting procedure is less than a first threshold. If the result of detection by the degree of tilt detecting procedure is not less than the first threshold but is less than a second threshold larger than the first threshold, in the correction controlling procedure, the tilt correcting process in the tilt correcting procedure is caused to be performed. In the stopping procedure, conveyance of the document by the conveyer is stopped if the result of detection by the degree of tilt detecting procedure is not less than the second threshold.

A control method for a document reading device according to the fourth aspect of the present invention includes conducting degree of tilt detection, conducting tilt correction, conducting correction control, and stopping conveyance. The document reading device includes a conveyer and an image reader. The conveyer conveys a document in sheet form along a conveyance path. The image reader reads an image of the document passing through an image reading position on the conveyance path midway through conveyance by the conveyer. Under such conditions, during the degree of tilt detection, a degree of tilt of the document with respect to a basic posture is detected upstream from the image reading position in a conveyance direction of the document. During the tilt correction, a tilt correcting process for correcting a tilt of a read image read by the image reader is performed based on a result of the degree of tilt detection. During the correction control, the tilt correcting process in the tilt correction is made unperformed if the result of the degree of tilt detection is less than a first threshold. If the result of the degree of tilt detection is not less than the first threshold but is less than a second threshold larger than the first threshold, during the correction control, the tilt correcting process in the tilt correction is caused to be performed. During the stopping of conveyance, conveyance of the document by the conveyer is stopped if the result of the degree of tilt detection is not less than the second threshold.

According to the present invention, it is possible to suppress the deterioration in performance of a document reading device and appropriately cope with inconveniences due to the conveyance of a tilting document.

### BRIEF DESCRIPTION OF THE DRAWINGS

FIG. 1 is a perspective view of a multifunction peripheral according to a first embodiment of the present invention.

FIG. 2 is a diagram illustrating a state, in which a document is placed on a document receiving tray of an automatic document feeder in the first embodiment, as viewed from above.

FIG. 3 is a diagram schematically illustrating an internal configuration of the automatic document feeder in the first embodiment.

FIG. 4 is a diagram illustrating arrangement positions of tilt sensors of the automatic document feeder in the first embodiment.

FIG. 5 is a diagram schematically illustrating one state where a document is conveyed by the automatic document feeder in the first embodiment.

FIG. 6 is a diagram schematically illustrating another state where the document is conveyed by the automatic document feeder in the first embodiment.

FIG. 7 is a block diagram illustrating an electrical configuration of the multifunction peripheral according to the first embodiment.

FIG. 8 is a diagram illustrating a memory map conceptually representing a configuration in a random access memory (RAM) of a main storage in the first embodiment.

FIG. 9 is a flowchart illustrating a flow of a document read controlling task in the first embodiment.

FIG. 10 is a diagram illustrating an example of a confirmation message screen in a second embodiment of the present invention.

FIG. 11 is a flowchart illustrating a flow of part of a document read controlling task in a second embodiment.

### DESCRIPTION OF THE PREFERRED EMBODIMENTS

### First Embodiment

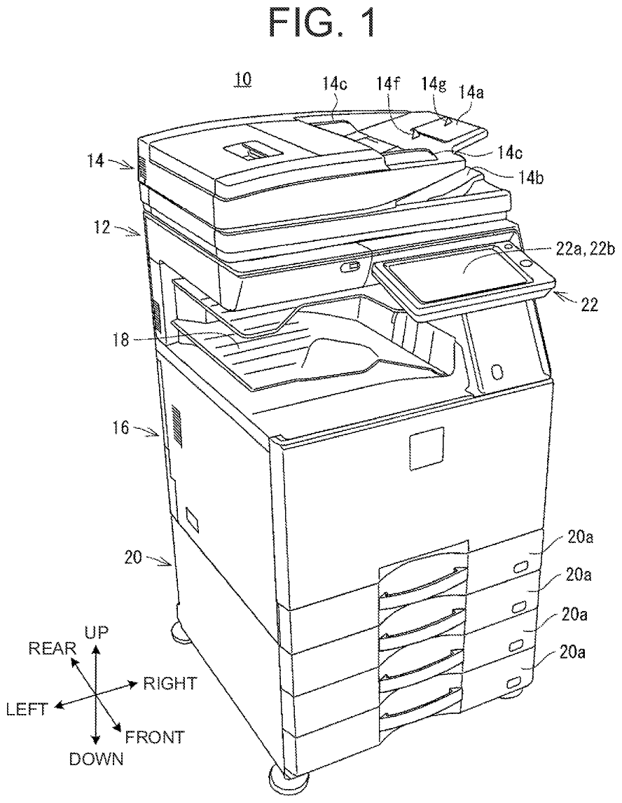

A first embodiment of the present invention is described taking a multifunction peripheral (MFP) 10 illustrated in FIG. 1 as an example.

The multifunction peripheral 10 according to the first embodiment has a plurality of functions, such as a copying function, a printing function, an image scanning function, and a faxing function. FIG. 1 is a perspective view of the multifunction peripheral 10, illustrating a front face, a top face, and a left side face of the multifunction peripheral 10 as installed in a state of being available. In other words, the up and down direction in FIG. 1 corresponds to the vertical direction of the multifunction peripheral 10. A lower right portion of FIG. 1 corresponds to the front of the multifunction peripheral 10, and an upper left portion of FIG. 1 corresponds to the rear of the multifunction peripheral 10. A lower left portion of FIG. 1 corresponds to the left of the multifunction peripheral 10, and an upper right portion of FIG. 1 corresponds to the right of the multifunction peripheral 10.

In an upper portion of the multifunction peripheral 10, an image reading section 12 is provided as an example of an image reader. The image reading section 12 takes on an image reading process for reading an image of a document 100 to be described later and generating two-dimensional read image data according to the read image. For such purpose, the image reading section 12 includes a document table not illustrated, on which the document 100 is placed. The document table is formed with a transparent member such as a glass plate in an approximately rectangular shape and provided so that both major faces of the document table may extend along a horizontal direction. Out of the major faces of the document table, an upper major face is the face, on which the document 100 is to be placed. Below the document table, an image reading unit not illustrated is provided. The image reading unit includes a light source, appropriate optical system components such as a mirror and a lens, and a licensor, and forms an image reading region in a linear form on the upper face (document placed face) of the document table. In addition, a drive mechanism not illustrated is provided below the document table. The drive mechanism moves the image reading region of the image reading unit along a direction perpendicular to the direction, in which the image reading region extends. In other words, the image reading region of the image reading unit is moved in the state, where the document 100 is placed on the document table, so that an image of the document 100 is two-dimensionally read in a so-called document fixing reading mode. The direction, in which the image reading region of the image reading unit extends, is referred to as a main scanning direction. The direction, in which the image reading region is moved by the drive mechanism, is referred to as a sub-scanning direction.

Above the document table, an automatic document feeder (ADF) 14 also serving as a document pressing down cover for pressing down the document 100 as placed on the document table is provided. The automatic document feeder 14 is so provided as to be able to transfer from a state of exposing the upper face of the document table to the outside to a state of covering the upper face of the document table, and vice versa. For such purpose, the automatic document feeder 14 is coupled to a main body (housing) of the multifunction peripheral 10 through a suitable fulcrum support member not illustrated, such as a hinge. FIG. 1 illustrates the state, in which the automatic document feeder 14 covers the upper face of the document table.

The automatic document feeder 14, which will be described in detail later, includes a document receiving tray 14a as an exemplary document receiving part. On the document receiving tray 14a, the document 100, strictly the document 100 in sheet form, is placeable and, especially, a plurality of documents 100 are stackable. The automatic document feeder 14 automatically feeds the document 100 placed on the document receiving tray 14a to the image reading section 12 one sheet at a time (sheet by sheet) so as to offer the document 100 to the image reading process performed by the image reading section 12. The document 100 after the image reading process by the image reading section 12 is discharged onto a document discharge tray 14b of the automatic document feeder 14. The automatic document feeder 14 functions as the automatic document feeder 14 (and not as the document pressing down cover) in the state, where the automatic document feeder 14 covers the upper face of the document table, as illustrated in FIG. 1, and any object (other than the automatic document feeder 14 itself) is not put on the document table.

Below the image reading section 12, an image forming section 16 is provided as an exemplary means of forming an image. The image forming section 16 takes on an image forming process for forming, namely, printing an image based on the image data for printing, which have been subjected to image processing by an image processing section 17 to be described later, on a sheet of paper not illustrated that is an exemplary image recording medium in sheet form. The image forming process is performed by a known electrophotographic method (Carlson process), for instance. For such purpose, the image forming section 16 includes a photosensitive drum, a charging device, an exposing device, a developing device, a transferring device, a fixing device, a cleaning device, and a discharging device, none of them being illustrated. The sheet of paper after the image forming process performed by the image forming section 16, so to speak, the sheet of paper after printing is discharged onto a paper discharge tray 18. The paper discharge tray 18 is provided in a so-called cavity space of the multifunction peripheral 10 between the image forming section 16 and the image reading section 12. The method for performing the image forming process is not limited to an electrophotographic method, and the image forming section 16 may perform the image forming process by an inkjet method.

Below the image forming section 16, that is to say, in a lower portion of the multifunction peripheral 10, a paper feed section 20 is provided as an exemplary means of paper feed. The paper feed section 20 includes a plurality of, four for instance, paper feed cassettes 20a. In each paper feed cassette 20a, appropriately sized sheets of paper are contained. For instance, sheets of paper differently sized from one another are contained in the paper feed cassettes 20a, respectively. Although not illustrated in FIG. 1, a bypass tray as an auxiliary paper feed tray is provided on a right side face of the multifunction peripheral 10. Assuming any of the paper feed cassettes 20a and the bypass tray as a paper feeder, the paper feed section 20 feeds a sheet of paper from the paper feeder to the image forming section 16 one sheet at a time so as to offer the sheet of paper to the image forming process performed by the image forming section 16.

In an upper portion of the multifunction peripheral 10, an operation unit 22 in the form of an approximately rectangular plate is provided in a front portion of the main body of the multifunction peripheral 10. The operation unit 22 is provided pivotably on a side edge of the operation unit 22 itself that is coupled to the main body of the multifunction peripheral 10. One main face (main face turned up in FIG. 1) of the operation unit 22 is an operation face and, on the operation face, a display 22b with a touch panel 22a is provided.

The display 22b with the touch panel 22a is the component, in which the display 22b having a rectangular display face and the touch panel 22a in sheet form, which is so provided as to lie on top of the display face of the display 22b, are integrally combined with each other. The touch panel 22a is an exemplary means of accepting an operation that is capable of accepting a touch operation by the user not illustrated, who uses the multifunction peripheral 10, and is, for instance, a projected capacitive panel. The display 22b is an exemplary means of display and is, for instance, a liquid crystal display (LCD). The touch panel 22a is not limited to a projected capacitive one but may be a panel of other type, such as a surface capacitance type, an electromagnetic induction type, a resistive film type, and an infrared type. The display 22b is not limited to a liquid crystal display but may be an organic electroluminescence (EL) display.

Conventionally, the user stands in front of the multifunction peripheral 10 so as to use the multifunction peripheral 10 and especially operate the operation unit 22. For the purpose of improving the operability and the visibility of the operation face of the operation unit 22 to the user operating the operation unit 22, the operation unit 22 is provided pivotably on a portion coupled to the multifunction peripheral 10 as described above, that is to say, provided so that the angle of the operation face may be adjustable to the user. The operation unit 22 includes an appropriate hardware switch, such as a push button switch, apart from the touch panel 22a. In addition, the operation unit 22 includes an appropriate means of light emission, such as a light emitting diode (LED), apart from the display 22b.

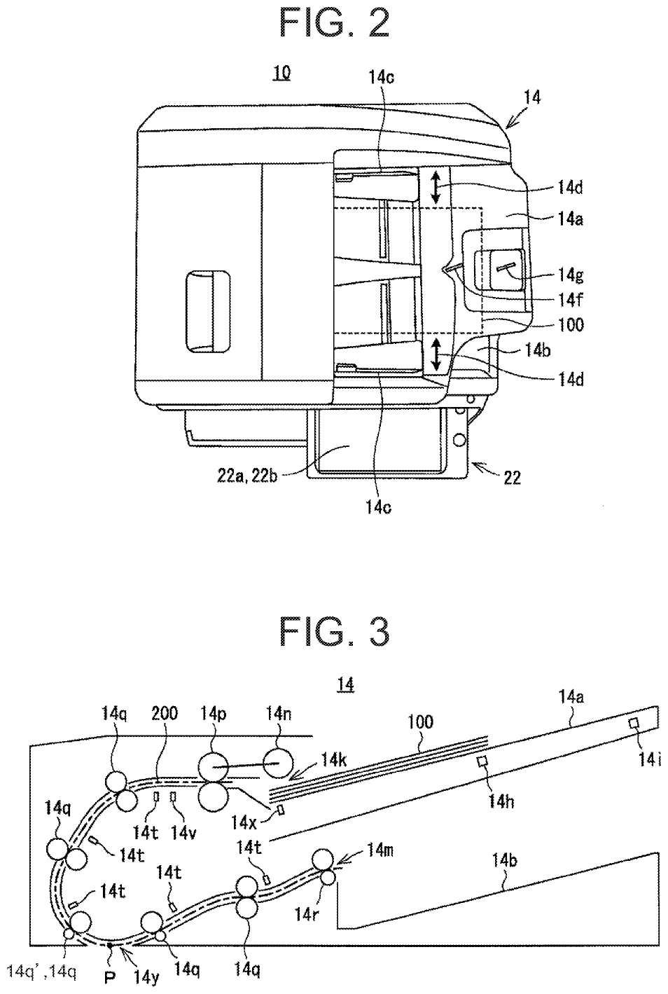

Paying attention to the automatic document feeder 14 with reference to FIG. 2 as well, the automatic document feeder 14 includes a pair of document guides 14c as an exemplary means of regulation. The document guides 14c regulate positions of both lateral edges of the document 100 in a width direction of the document 100 placed on the document receiving tray 14a, strictly speaking, in a direction perpendicular to a conveyance direction of the document 100, which is conveyed as described later, so to speak, a conveyance width direction (the up and down direction in FIG. 2, for instance). To be specific: The document guides 14c are optionally movable (slidable) by hand along the conveyance width direction, as indicated with arrows 14d in FIG. 2. The document guides 14c as such come into contact with both lateral edges in the conveyance width direction of the document 100 so as to mechanically regulate the positions of both lateral edges in the conveyance width direction of the document 100. The document guides 14c link together to symmetrically move. In other words, if one document guide 14c is moved, the other document guide 14c links with the moved document guide 14c so as to move in a symmetrical manner. In FIG. 2, the document 100 is illustrated with a broken line taking account of the obviousness of FIG. 2 and for the convenience of description.

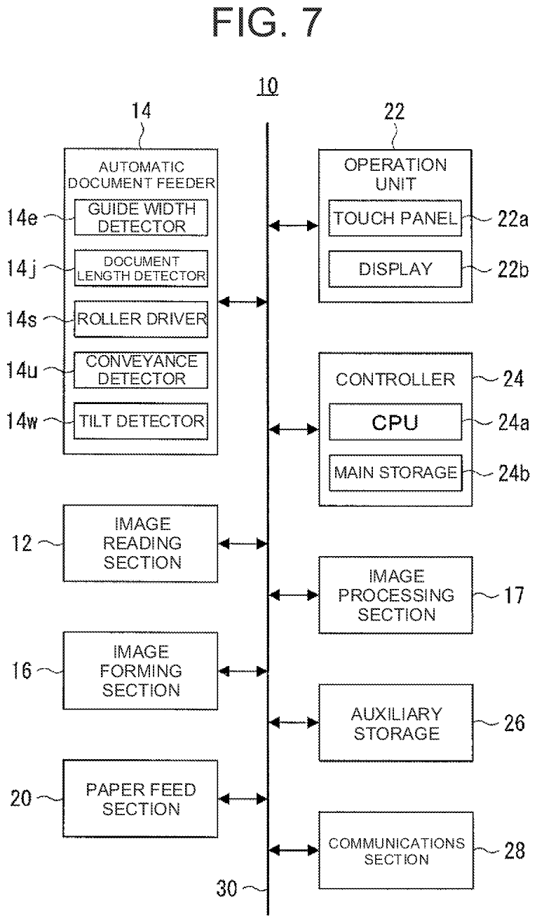

Although not illustrated in either of FIGS. 1 and 2, the automatic document feeder 14 includes a guide width detector 14e (see FIG. 7) to be described later as an exemplary means of detecting a position of regulation. The guide width detector 14e detects a position of regulation by the document guides 14c and, in consequence, detects a guide width as a distance between the document guides 14c. Consequently, the guide width mostly corresponds to the width of the document 100 as a size in the conveyance width direction of the document 100 if the positions of both lateral edges in the conveyance width direction of the document 100 have been regulated by the document guides 14c, for instance. While detailed description including illustrating in a figure is omitted, the guide width detector 14e includes a variable resistor so provided as to have a resistance value according to one or both of the positions of the document guides 14c, and detects the guide width based on the resistance value of the variable resistor. Instead of such configuration, the guide width detector 14e may have the configuration, in which an appropriate sensor such as an optical sensor is used to detect one or both of the positions of the document guides 14c and, in consequence, detect the guide width.

The automatic document feeder 14 further includes a plurality of, two for instance, document detecting pieces 14f and 14g each in the form of a depressed protrusion. The two document detecting pieces 14f and 14g are arranged in appropriate, different positions in the conveyance direction (the right and left direction in FIG. 2, for instance) on the document receiving tray 14a approximately in the center in the conveyance width direction of the document receiving tray 14a. Each of the document detecting pieces 14f and 14g is protruded above an upper face (document placed face) of the document receiving tray 14a if an external force, especially an external force from above, is not applied to the relevant document detecting piece. If applied with an external force, or if covered with the document 100, for instance, the document detecting pieces 14f and 14g are each pushed into the document receiving tray 14a by the weight of the document 100. In other words, the document detecting pieces 14f and 14g each have such configuration.

Although not illustrated in either of FIGS. 1 and 2, the automatic document feeder 14 further includes two document length sensors 14h and 14i (see FIG. 3) to be described later that are used to detect states of the document detecting pieces 14f and 14g, respectively. The document length sensors 14h and 14i are provided correspondingly to the document detecting pieces 14f and 14g, respectively. In other words, the document length sensor 14h is so provided as to detect the state of the document detecting piece 14f and outputs a signal in a mode according to the state of the document detecting piece 14f. The document length sensor 14i is so provided as to detect the state of the document detecting piece 14g and outputs a signal in a mode according to the state of the document detecting piece 14g. The document length sensors 14h and 14i are each an optical sensor, specifically a transmission-type optical sensor, for instance. The document length sensors 14h and 14i cooperate with the document detecting pieces 14f and 14g to constitute a document length detector 14j (see FIG. 7) to be described later.

Paying attention to the inside of the automatic document feeder 14 with reference to FIG. 3, the automatic document feeder 14 has a document conveyance path 200 extending from a document feed port 14k on the document receiving tray 14a side to a document discharge port 14m on the document discharge tray 14b side. FIG. 3 is a schematic diagram illustrating the inside of the automatic document feeder 14 as viewed from the front of the multifunction peripheral 10. As illustrated in FIG. 3, the document conveyance path 200 is approximately U-shaped (or approximately C-shaped), for instance.

In the vicinity of the document feed port 14k of the document conveyance path 200, a pickup roller 14n is provided. The pickup roller 14n takes out the document 100 placed on the document receiving tray 14a from the document receiving tray 14a one sheet at a time. The document 100 as taken out from the document receiving tray 14a by the pickup roller 14n is brought into the document conveyance path 200 through the document feed port 14k. For such purpose, a document feed roller pair 14p is provided at an end on the document feed port 14k side, so to speak, an end on the upstream side of the document conveyance path 200.

On the document conveyance path 200, a plurality of conveyance roller pairs 14q are appropriately provided. The conveyance roller pairs 14q each make the document 100 as brought into the document conveyance path 200 conveyed along the document conveyance path 200 (that is to say, so conveyed as to follow the document conveyance path 200). In addition, the document conveyance path 200 has a portion 14y adjoining to the upper face of the document table as described above. In the portion 14y, the image reading region as above, in which an image is to be read by the image reading section 12, is fixedly arranged so as to arrange a so-called image reading position P, when the automatic document feeder 14 functions as the automatic document feeder 14 (and not as the document pressing down cover). The image reading position P (image reading region) extends along the main scanning direction (direction perpendicular to the plane of FIG. 3).

In other words, the document 100, which is conveyed along the document conveyance path 200, passes through the image reading position P midway through the conveyance. Thus, the image reading position P moves relatively to the document 100 in the conveyance direction of the document 100, that is to say, in the sub-scanning direction. As a result, an image of the document 100 is two-dimensionally read in a so-called document moving reading mode. The automatic document feeder 14, which enables such image reading process in the document moving reading mode, is also referred to as a surface pass feeder (SPF). Among the conveyance roller pairs 14q, a conveyance roller pair 14q′ located immediately before the image reading position P in the conveyance direction of the document 100 (that is to say, located nearest to the image reading position P upstream from the image reading position P) also serves as a register roller pair for adjusting the timing for feeding the document 100 to the image reading position P.

The document 100, which has passed through the image reading position P, is discharged onto the document discharge tray 14b through the document discharge port 14m at an end on the downstream side of the document conveyance path 200. At the document discharge port 14m, a document discharge roller pair 14r is provided. Apart from the document discharge roller pair 14r, the pickup roller 14n, the document feed roller pair 14p, and the conveyance roller pairs 14q are each driven by a roller driver 14s (see FIG. 7) to be described later.

Also on the document conveyance path 200, a plurality of document conveyance sensors 14t are appropriately provided. The document conveyance sensors 14t each detect the document 100 on the document conveyance path 200, namely, the position (conveyance position) of the document 100 on the document conveyance path 200. The document conveyance sensors 14t are each an optical sensor, specifically a reflection-type optical sensor, for instance. The document conveyance sensors 14t are each a component of a conveyance detector 14u (see FIG. 7) to be described later.

Further, tilt sensors 14v, strictly two tilt sensors 14v, are provided in appropriate positions on the upstream side on the document conveyance path 200, positions between the document conveyance sensor 14t, which is located most upstream among the document conveyance sensors 14t, and the document feed roller pair 14p, for instance. The two tilt sensors 14v constitute a tilt detector 14w (see FIG. 7) to be described later as an example of a degree of tilt detector. The tilt sensors 14v are sensors with the same specifications, and are each a reflection-type optical sensor, for instance.

In an appropriate position in the document receiving tray 14a, in a position in the document receiving tray 14a that is near to the document feed port 14k, for instance, a document placement sensor 14x is provided. The document placement sensor 14x is an exemplary means of detecting reception of a document that is used to detect whether the document 100 is placed on the document receiving tray 14a. The document placement sensor 14x is also a reflection-type optical sensor, for instance. In appropriate positions in the document receiving tray 14a, the document length sensors 14h and 14i as described above are provided, respectively. The document length sensor 14h is provided correspondingly to the document detecting piece 14f, which is not illustrated in FIG. 3, and detects the state of the document detecting piece 14f. The document length sensor 14i is provided correspondingly to the document detecting piece 14g, which is not illustrated in FIG. 3, and detects the state of the document detecting piece 14g.

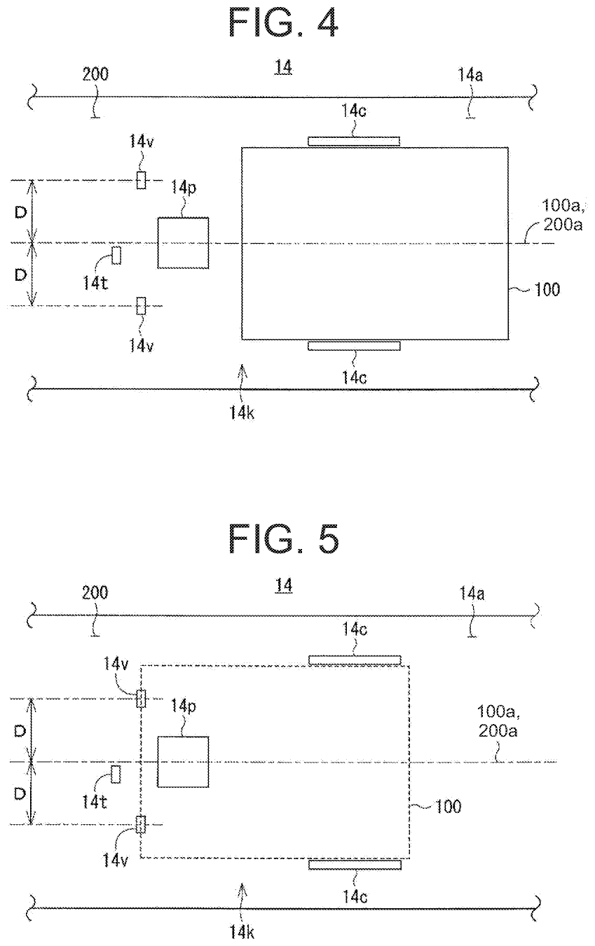

As illustrated in FIG. 4, the two tilt sensors 14v are symmetrically provided with respect to a center line 200a of the document conveyance path 200 (that is a line representing a center in the conveyance width direction (the up and down direction in FIG. 4) of the document conveyance path 200). To be specific: The tilt sensors 14v are provided in the same (conjugate) positions in the conveyance direction (the right and left direction in FIG. 4), particularly between the document conveyance sensor 14t located most upstream and the document feed roller pair 14p, as described above. The positions, where the tilt sensors 14v are provided, are each separated from the center line 200a of the document conveyance path 200 by a distance D in the conveyance width direction.

The distance D is 70 mm, for instance. Consequently, a distance 2·D between the tilt sensors 14v in the conveyance width direction is 140 mm. The distance 2·D is determined according to the minimum size of the document 100. In the present embodiment, the A5 paper size is assumed as the minimum size of the document 100, so that the distance 2·D is determined to be of a somewhat smaller value (140 mm) as compared with the shorter side size, 148 mm, of the A5 paper size.

FIG. 4 illustrates the state, in which the document 100 is placed on the document receiving tray 14a and the positions of both lateral edges in the conveyance width direction of the document 100 are regulated by the document guides 14c. In such state, a center line 100a in the conveyance width direction of the document 100 essentially agrees with the center line 200a of the document conveyance path 200. In other words, both lateral edges in the conveyance width direction of the document 100 are essentially parallel to the center line 200a of the document conveyance path 200. A posture of the document 100, which is in the state as above, is referred to as a basic posture. While, in FIG. 4, the document conveyance sensor 14t (located most upstream) is in a position off the center line 200a of the document conveyance path 200, the document conveyance sensors 14t may each be provided on the center line 200a of the document conveyance path 200.

It is assumed that, in the state illustrated in FIG. 4, the document 100 placed on the document receiving tray 14a is brought into the document conveyance path 200 through the document feed port 14k and conveyed along the document conveyance path 200. It is also assumed that an end edge on the downstream side (end edge on the left in FIG. 5) of the document 100 reaches the positions, where the tilt sensors 14v are arranged, respectively, in a state where the document 100 maintains the basic posture, as illustrated in FIG. 5. In that case, the end edge on the downstream side of the document 100 is detected by the respective tilt sensors 14v at the same time. In other words, the time when the end edge on the downstream side of the document 100 is detected by one tilt sensor 14v and the time when the end edge on the downstream side of the document 100 is detected by the other tilt sensor 14v conform with each other. In FIG. 5, the document 100 is illustrated with a broken line taking account of the obviousness of FIG. 5 and for the convenience of description.

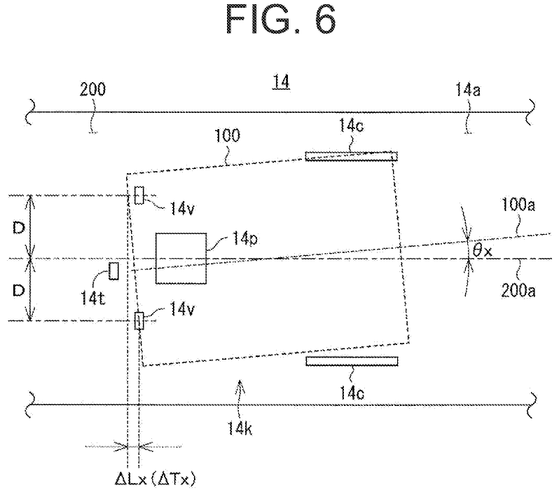

On the other hand, it is assumed that the document 100 is conveyed in a state of tilting at an oblique angle with respect to the basic posture, that is to say, obliquely moves, as illustrated in FIG. 6. In that case, a difference in time ΔTx is made between the time when the end edge on the downstream side of the document 100 reaches the position, in which one tilt sensor 14v is arranged, and the time when the end edge on the downstream side of the document 100 reaches the position, in which the other tilt sensor 14v is arranged, that is to say, between the time when the end edge on the downstream side of the document 100 is detected by one tilt sensor 14v and the time when the end edge on the downstream side of the document 100 is detected by the other tilt sensor 14v. In other words, a difference in position ΔLx is made in the conveyance direction between the position, in which the end edge on the downstream side of the document 100 is detected by one tilt sensor 14v, and the position, in which the end edge on the downstream side of the document 100 is detected by the other tilt sensor 14v. Also in FIG. 6, the document 100 is illustrated with a broken line taking account of the obviousness of FIG. 6 and for the convenience of description.

The relationship between the difference in position ΔLx and the difference in time ΔTx is expressed by Equation 1 below, in which Vx represents the conveyance speed of the document 100.

ΔLx=Vx·ΔTx Equation 1

An angle θx as an angle of the center line 100a of the document 100 with the center line 200a of the document conveyance path 200, so to speak, an angle of tilt (angle of oblique movement) of the document 100 is expressed by Equation 2 below.

θx=arctan{ΔLx/(2·D)} Equation 2

The angle of tilt θx based on Equation 2 can have not only a positive value but a negative value. If, as in FIG. 6, the time when the end edge on the downstream side of the document 100 is detected by one tilt sensor 14v (located upside in FIG. 6) is earlier than the time when the end edge on the downstream side of the document 100 is detected by the other tilt sensor 14v (located downside in FIG. 6), the angle of tilt θx has a positive value. In contrast, if the time when the end edge on the downstream side of the document 100 is detected by one tilt sensor 14v (located upside in FIG. 6) is later than the time when the end edge on the downstream side of the document 100 is detected by the other tilt sensor 14v (located downside in FIG. 6), the angle of tilt θx has a negative value. In other words, whether the value of the angle of tilt θx is positive or negative depends on the direction, in which the document 100 tilts with respect to the basic posture.

In such conditions, it is assumed, for instance, that the document 100 is conveyed in a state of tilting as illustrated in FIG. 6 and the document 100 as such passes through the image reading position P. In that case, a read image of the document 100 that is read in the image reading position P is in a state (has contents) according to the tilt of the document 100, so to speak, a state of tilting. The degree of tilt of the read image of the document 100, that is to say, the degree of tilt of the document 100 with respect to the basic posture is acceptable if such degree of tilt is relatively small. If the degree of tilt of the document 100 with respect to the basic posture is relatively large, it is desirable to suitably conduct tilt correction. If the degree of tilt of the document 100 is extremely large, it is desirable to stop the conveyance of the document 100 at once because the document 100 may suffer such damage as getting caught in a lateral edge portion of the document conveyance path 200 and broken.

In the first embodiment, the tilt of the document 100 is deemed to be acceptable and no tilt correction is conducted if the angle of tilt θx based on Equation 2, strictly the absolute value |θx| of the angle of tilt θx, is less than a specified first threshold θa (|θx|<θa). If the absolute value |θx| of the angle of tilt θx of the document 100 is not less than the first threshold θa but is less than a specified second threshold θb (θa≤|θx|<θb), the tilt of the read image of the document 100 is corrected, that is to say, tilt correction is conducted by image processing. If the absolute value |θx| of the angle of tilt θx of the document 100 is not less than the second threshold θb (θb≤|θx|), the conveyance of the document 100 is stopped at once. The first threshold θa is 0.5 degrees, for instance. The second threshold θb, which is larger than the first threshold θa (θb>θa), is 1.5 degrees, for instance.

In other words, the tilt of the document 100 is deemed to be acceptable and no tilt correction is conducted if the degree of tilt of the document 100 with respect to the basic posture is relatively small. Tilt correction is conducted by image processing only if the degree of tilt of the document 100 with respect to the basic posture is relatively large. If the degree of tilt of the document 100 with respect to the basic posture is extremely large, the conveyance of the document 100 is stopped at once. As a matter of course, no tilt correction is conducted, nor is the conveyance of the document 100 stopped if the document 100 is not tilting.

FIG. 7 is a block diagram illustrating an electrical configuration of the multifunction peripheral 10. As illustrated in FIG. 7, the multifunction peripheral 10 includes, apart from the image reading section 12, the automatic document feeder 14, the image forming section 16, the paper feed section 20, and the operation unit 22, the image processing section 17, a controller 24, an auxiliary storage 26, and a communications section 28. Such components are connected to one another through a common bus 30. The image reading section 12, the automatic document feeder 14, the image forming section 16, the paper feed section 20, and the operation unit 22 are as described above.

The image processing section 17 performs appropriate image processing on various kinds of image data including the read image data generated by the image reading section 12. The image processing includes image processing for output that is performed in order to generate image data for output. For instance, in the copying function and the printing function, image data for printing appropriately shaped for the image forming process performed by the image forming section 16 are generated as image data for output. Also in the case where so-called output to paper is designated in a fax receiving function included in the faxing function, image data for printing appropriately shaped for the image forming process performed by the image forming section 16 for the sake of the output to paper are generated as image data for output. In the image scanning function, image data appropriately shaped for saving or for transmission are generated as image data for output. In a fax transmitting function included in the faxing function, image data appropriately shaped for fax transmission are generated as image data for output. If saving of fax reception data is designated in the fax receiving function, fax reception data appropriately shaped for saving are generated as image data for output.

The image processing section 17 also takes on the tilt correction by image processing as described above. In the tilt correction by image processing, the tilt of an image for output from image data for output is corrected based on the angle of tilt Ox of the document 100. The image data after correction, in which the tilt has been corrected, are thus generated.

The controller 24 is an exemplary means of control that presides over total control of the multifunction peripheral 10. For such control, the controller 24 includes a computer as a means of exerting control, a central processing unit (CPU) 24a, for instance. In addition, the controller 24 includes a main storage 24b as a main means of storage directly accessible to the CPU 24a. The main storage 24b includes a random access memory (RAM) and a read-only memory (ROM) neither illustrated. In the ROM, a control program for controlling operations of the CPU 24a, so-called firmware, is stored. The RAM constitutes a working region and a buffer region that are used when the CPU 24a performs a process based on the control program.

The auxiliary storage 26 is an example of an auxiliary means of storage. In the auxiliary storage 26, various kinds of data including the read image data as above are stored as appropriate. The auxiliary storage 26 includes a hard disk drive not illustrated, for instance. The auxiliary storage 26 may include a rewritable non-volatile memory such as a flash memory.

The communications section 28 is an exemplary means of communications. The communications section 28 is connected to a communications network not illustrated and thereby takes on interactive communications over the communications network. Examples of the communications network include a local area network (LAN), the Internet, and a public switched telephone network. The LAN includes a wireless LAN.

Paying attention anew to the automatic document feeder 14, the automatic document feeder 14 includes the guide width detector 14e, the document length detector 14j, the roller driver 14s, the conveyance detector 14u, and the tilt detector 14w. As described above, the guide width detector 14e detects the position of regulation by the document guides 14c and, in consequence, detects the guide width as a distance between the document guides 14c.

The document length detector 14j includes the document detecting pieces 14f and 14g and the document length sensors 14h and 14i. The document length detector 14j detects the document length as a size in the conveyance direction of the document 100, strictly a rough document length, based on output signals from the respective document length sensors 14h and 14i, that is to say, based on the states of the respective document detecting pieces 14f and 14g.

The result of detection by the guide width detector 14e (guide width) and the result of detection by the document length detector 14j (document length) are offered to a document size detection process for detecting the size of the document 100. The document size detection process is taken on by the CPU 24a. In other words, the CPU 24a detects (calculates) the size of the document 100 based on the result of detection by the guide width detector 14e and the result of detection by the document length detector 14j.

As described above, the roller driver 14s drives each of the pickup roller 14n, the document feed roller pair 14p, the conveyance roller pairs 14q, and the document discharge roller pair 14r. The roller driver 14s cooperates with the pickup roller 14n, the document feed roller pair 14p, the conveyance roller pairs 14q, and the document discharge roller pair 14r to constitute an example of a conveyer.

The conveyance detector 14u includes the document conveyance sensors 14t. The conveyance detector 14u detects the position of the document 100 on the document conveyance path 200 based on output signals from the respective document conveyance sensors 14t.

The tilt detector 14w is an example of the degree of tilt detector and includes the tilt sensors 14v. The tilt detector 14w detects the degree of tilt of the document 100 with respect to the basic posture based on output signals from the respective tilt sensors 14v. To be specific: The tilt detector 14w finds the difference in time ΔTx as above based on output signals from the respective tilt sensors 14v and, in consequence, finds the difference in position ΔLx based on Equation 1, and further finds the angle of tilt θx of the document 100 based on Equation 2.

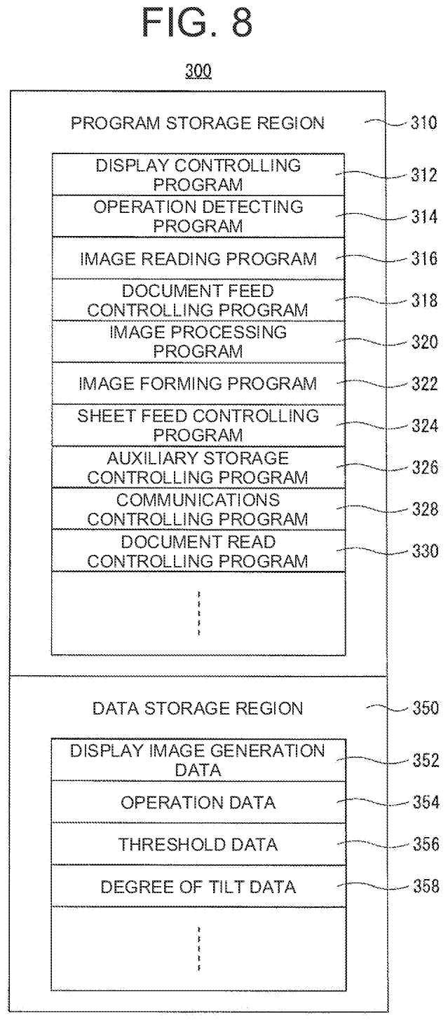

FIG. 8 illustrates a memory map 300 conceptually representing a configuration in the RAM of the main storage 24b. As illustrated in the memory map 300, the RAM has a program storage region 310 and a data storage region 350.

In the program storage region 310, the control program as above is stored. Specifically, the control program includes a display controlling program 312, an operation detecting program 314, an image reading program 316, a document feed controlling program 318, an image processing program 320, an image forming program 322, and a paper feed controlling program 324. In addition, the control program includes an auxiliary storage controlling program 326 and a communications controlling program 328. The control program also includes a document read controlling program 330.

The display controlling program 312 is a program for generating display screen data required for the display of various screens including a home screen not illustrated on the display 22b. The operation detecting program 314 is a program for detecting the state of operation on the touch panel 22a. The image reading program 316 is a program for controlling the image reading section 12. The document feed controlling program 318 is a program for controlling the automatic document feeder 14. The image processing program 320 is a program for controlling the image processing section 17. The image forming program 322 is a program for controlling the image forming section 16. The paper feed controlling program 324 is a program for controlling the paper feed section 20. The auxiliary storage controlling program 326 is a program for controlling the auxiliary storage 26. The communications controlling program 328 is a program for controlling the communications section 28. The document read controlling program 330 is a program for causing the CPU 24a to execute a document read controlling task to be described later.

In the data storage region 350, various kinds of data are stored. Examples of the various kinds of data include display image generation data 352, operation data 354, threshold data 356, and degree of tilt data 358.

The display image generation data 352 are such data as polygon data and texture data used to generate display screen data based on the display controlling program 312 as above. The operation data 354 are data representing the state of operation on the touch panel 22a, particularly time series data representing the position (coordinates) of a touch given by a user to the touch panel 22a. The threshold data 356 are data representing the first threshold θa. The threshold data 356, namely, the first threshold θa is optionally changeable. For instance, the first threshold θa can optionally be changed by a service person in charge of the maintenance of the multifunction peripheral 10. The second threshold θb is basically unchangeable and data representing the second threshold θb, for instance, are incorporated into the document read controlling program 330. The degree of tilt data 358 are data representing the angle of tilt θx of the document 100.

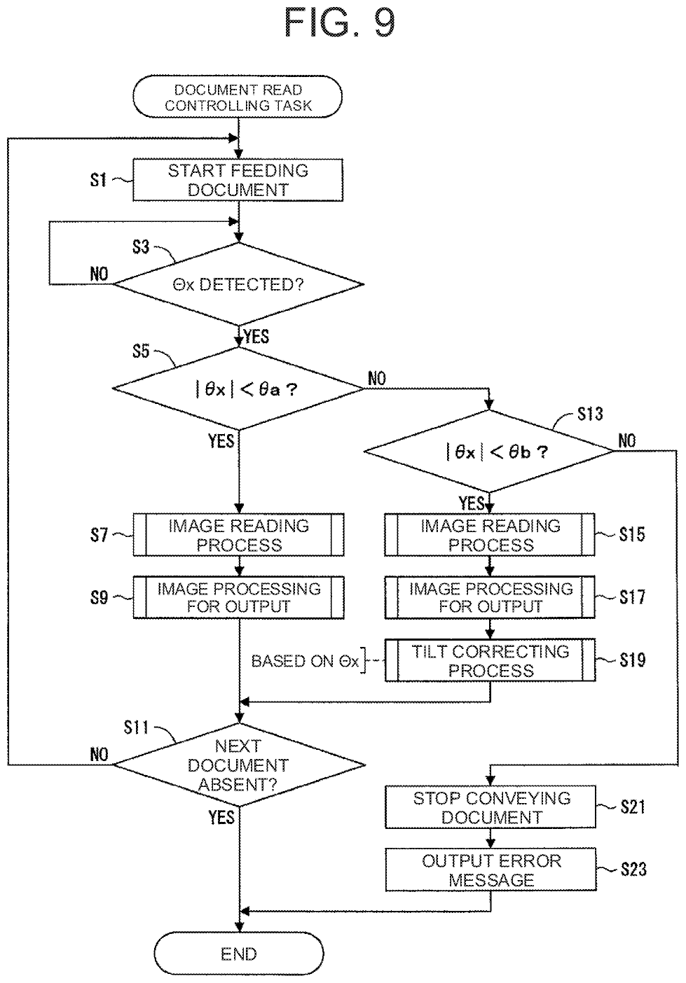

The CPU 24a executes the document read controlling task in accordance with the document read controlling program 330. FIG. 9 illustrates the flow of the document read controlling task. The CPU 24a executes the document read controlling task in response to an operation instructing to start the feed of the document 100 by the automatic document feeder 14 if such operation is accepted by the operation unit 22 (the touch panel 22a) in the state, where the document 100 is placed on the document receiving tray 14a.

According to the document read controlling task, initially in step S1, the CPU 24a starts the feed of the document 100 by the automatic document feeder 14, strictly speaking, controls the automatic document feeder 14 (the roller driver 14s) to start the feed of the document 100. As a result, the document 100 as placed on the document receiving tray 14a is brought into the document conveyance path 200 one sheet at a time and conveyed along the document conveyance path 200. After performing the process in step S1, the CPU 24a makes the processing proceed to step S3.

In step S3, the CPU 24a waits until the angle of tilt θx of the document 100 is detected by the tilt detector 14w (NO in step S3). If the angle of tilt θx of the document 100 is detected (YES in step S3), the CPU 24a makes the processing proceed to step S5.

In step S5, the CPU 24a compares the absolute value |θx| of the angle of tilt θx of the document 100 as detected in step S3 with the first threshold θa based on the threshold data 356. If the absolute value |θx| of the angle of tilt θx is less than the first threshold θa (|θx|<θa) (YES in step S5), the CPU 24a makes the processing proceed to step S7. If the absolute value |θx| of the angle of tilt θx is not less than the first threshold θa (|θx|≥θa) (NO in step S5), the CPU 24a makes the processing proceed to step S13 to be described later.

In step S7, the CPU 24a performs the image reading process in the document moving reading mode, strictly speaking, controls the image reading section 12 to perform the image reading process in the document moving reading mode. As a result, read image data are generated according to an read image of the document 100. Then, the CPU 24a makes the processing proceed to step S9.

In step S9, the CPU 24a performs the image processing for output, strictly speaking, controls the image processing section 17 to perform the image processing for output. As a result, image data for output are generated based on the read image data. To be specific: As described above, in the copying function, for instance, image data for printing are generated as image data for output. In the image scanning function, image data for saving or for transmission are generated as image data for output. In the fax transmitting function, image data for fax transmission are generated as image data for output. After performing the process in step S9, the CPU 24a makes the processing proceed to step S11.

In step S11, the CPU 24a determines whether the next document 100 is present, that is to say, whether the document 100 is placed on the document receiving tray 14a. Such determination is made based on an output signal from the above-mentioned document placement sensor 14x (see FIG. 3). If the next document 100 is present (NO in step S11), the CPU 24a makes the processing return to step S1 in order to start the feed of the next document 100. If the next document 100 is absent (YES in step S11), the CPU 24a terminates the document read controlling task.

If making the processing proceed from step S5 to step S13, the CPU 24a compares, in step S13, the absolute value |θx| of the angle of tilt θx of the document 100 as detected in step S3 with the second threshold θb incorporated in the document read controlling program 330. If the absolute value |θx| of the angle of tilt θx is less than the second threshold θb (|θx|<θb), that is to say, the absolute value |θx| of the angle of tilt θx is not less than the first threshold θa but is less than the second threshold θb (θa≤|θx|<θb) (YES in step S13), the CPU 24a makes the processing proceed to step S15. If the absolute value |θx| of the angle of tilt θx is not less than the second threshold θb (|θx|≥θb) (NO in step S13), the CPU 24a makes the processing proceed to step S21 to be described later.

In step S15, the CPU 24a performs the image reading process in the document moving reading mode, strictly speaking, controls the image reading section 12 to perform the image reading process in the document moving reading mode, as is the case with step S7. As a result, read image data are generated according to a read image of the document 100. Then, the CPU 24a makes the processing proceed to step S17.

In step S17, the CPU 24a performs the image processing for output, strictly speaking, controls the image processing section 17 to perform the image processing for output, as is the case with step S9. As a result, image data for output are generated based on the read image data. Then, the CPU 24a makes the processing proceed to step S19.

In step S19, the CPU 24a conducts the tilt correction by image processing on the image data for output, strictly speaking, controls the image processing section 17 to conduct the tilt correction by image processing on the image data for output. Consequently, the image processing section 17 performs a tilt correcting process for correcting the tilt of an image for output coming from the image data for output based on the angle of tilt θx of the document 100, that is to say, based on the result of detection by the tilt detector 14w (and not on the read image data nor the image data for output). The image data after correction, in which the tilt has been corrected, are thus generated. Such image data after correction are treated as image data for output. After performing the process in step S19, the CPU 24a makes the processing proceed to step S11.

If making the processing proceed from step S13 to step S21, the CPU 24a stops, in step S21, the conveyance of the document 100, strictly speaking, controls the automatic document feeder 14 to stop the conveyance of the document 100. Then, the CPU 24a makes the processing proceed to step S23.

In step S23, the CPU 24a outputs an error message notifying that the conveyance of the document 100 has been stopped. The error message may be output visually by displaying an error message screen not illustrated on the display 22b or aurally by outputting a specified voice message or a buzzer sound. By performing the process in step S23, the CPU 24a terminates the document read controlling task.

While detailed description including illustrating in a figure is omitted, a task for outputting image data for output is executed apart from the document read controlling task. As a result of the execution of such task, in the copying function, for instance, image data for output are offered to the image forming process performed by the image forming section 16, and an image coming from the image data for output is formed on a sheet of paper. In the image scanning function, image data for output are saved at a saving location designated in advance or transmitted to a transmission destination designated in advance. In the fax transmitting function, image data for output are transmitted to a fax transmission destination designated in advance.

According to the first embodiment as described above, the tilt of the document 100 is deemed to be acceptable and no tilt correction is conducted if the degree of tilt of the document 100 with respect to the basic posture is relatively small. Tilt correction is conducted by image processing only if the degree of tilt of the document 100 with respect to the basic posture is relatively large. In other words, the tilt correction by image processing is conducted in limited cases. Consequently, the deterioration in performance of the multifunction peripheral 10 due to the tilt correction by image processing is suppressed. If the degree of tilt of the document 100 with respect to the basic posture is extremely large, the conveyance of the document 100 is stopped at once. As a result, the damage to the document 100, which is caused by the fact that the document 100 gets caught in a lateral edge portion of the document conveyance path 200, is avoided. In effect, according to the first embodiment, it is possible to appropriately cope with inconveniences due to the conveyance of the document 100 in a state of tilting while suppressing the deterioration in performance of the multifunction peripheral 10.

The image processing section 17, which performs the tilt correcting process as above, is an example of a tilt corrector. The CPU 24a, which executes the document read controlling task (see FIG. 9) and especially performs the processes in steps S1 through S19, is an example of a correction controller. The CPU 24a, which performs the process in step S21, is an example of a stopper. The image forming section 16, which is used in the copying function, that is to say, performs the image forming process based on image data for output, is an example of an image outputting device. If, in the image scanning function, image data for output are saved at a saving location designated in advance, for instance, the CPU 24a takes on a process for such saving, and the CPU 24a as such is another example of the image outputting device. If image data for output are transmitted to a transmission destination designated in advance in the image scanning function, the CPU 24a and the communications section 28 take on a process for such transmission, and the CPU 24a and the communications section 28 as such are yet another example of the image outputting device. In addition, if image data for output are transmitted to a fax transmission destination designated in advance in the fax transmitting function, the CPU 24a and the communications section 28 take on a process for such transmission, and the CPU 24a and the communications section 28 as such are also an example of the image outputting device.

### Second Embodiment

Next, a second embodiment of the present invention is described.

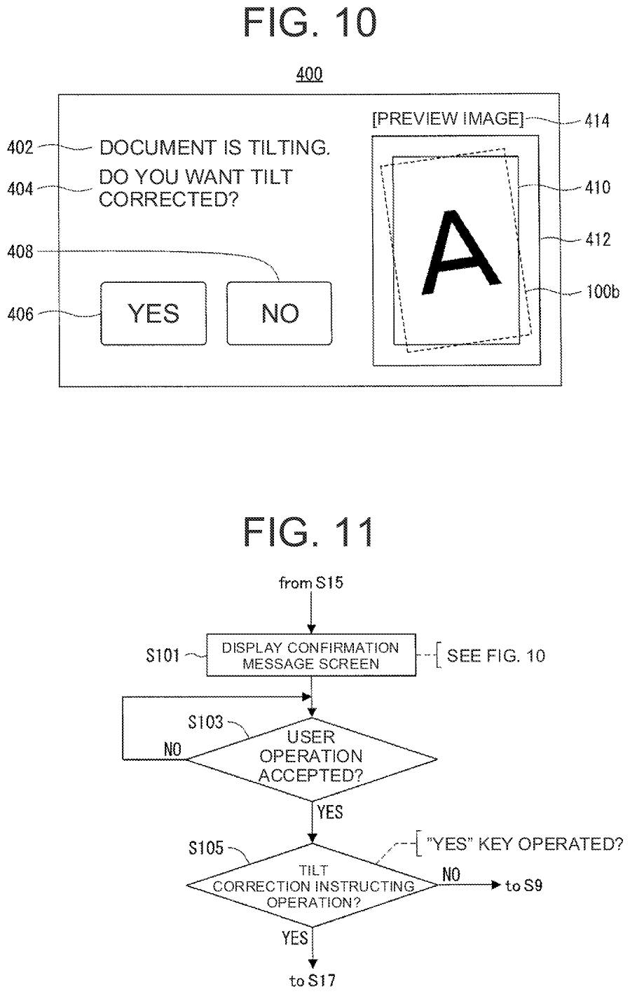

In the second embodiment, a confirmation message screen 400 illustrated in FIG. 10 is displayed on the display 22b if the degree of tilt of the document 100 is relatively large, that is to say, if the absolute value |θx| of the angle of tilt θx of the document 100 is not less than the first threshold θa but is less than the second threshold θb. The confirmation message screen 400 is a screen for inquiring of a user whether the user wishes the tilt correction by image processing as described above conducted (the tilt correcting process performed).

To be specific: In an upper, left side position on the confirmation message screen 400, a suitable character string 402 expressing the fact that the document 100 is tilting is arranged. Below the character string 402, a suitable character string 404 with contents inquiring of a user whether tilt correction is to be conducted is arranged. In addition, two operation keys 406 and 408 are arranged below the character string 404. The operation key 406 on the left, for instance, is a key for instructing to conduct tilt correction, so to speak, a “YES” key. The operation key 408 on the right is a key for instructing not to conduct tilt correction, so to speak, a “NO” key.

On the right on the confirmation message screen 400, a preview image 410 is displayed based on read image data. To be specific: On the right on the confirmation message screen 400, a preview display region 412 in a rectangular shape is arranged for the display of the preview image 410. The preview image 410 is displayed in the preview display region 412. A broken line 100b giving a rectangle in FIG. 10 is a virtual line expediently representing the document 100 in a state of tilting and is actually not displayed. In an appropriate position near the preview display region 412, above the preview display region 412, for instance, a suitable character string 414 expressing the title of the preview image 410 is arranged.

It is assumed that the “YES” key 406 is operated (touched) on the confirmation message screen 400. In that case, the tilt correction by image processing as above is conducted in response to the operation of the “YES” key 406. In other words, in the second embodiment, the tilt correction by image processing is conducted if the absolute value |θx| of the angle of tilt θx of the document 100 is not less than the first threshold θa but is less than the second threshold θb and, in addition to that, the “YES” key 406 on the confirmation message screen 400 is operated.

If the “NO” key 408 on the confirmation message screen 400 is operated, the tilt correction by image processing is not conducted. In other words, in the second embodiment, the tilt correction by image processing is not conducted if the “NO” key 408 on the confirmation message screen 400 is operated, even if the absolute value |θx| of the angle of tilt θx of the document 100 is not less than the first threshold θa but is less than the second threshold θb.

In the second embodiment as described above, steps S101 through S105 illustrated in FIG. 11 are provided between steps S15 and S17 of the document read controlling task (see FIG. 9).

After performing the process in step S15, the CPU 24a makes the processing proceed to step S101. In step S101, the CPU 24a displays the confirmation message screen 400 on the display 22b. The display of the confirmation message screen 400 may be accompanied with an inquiry by voice addressed to a user. After performing the process in step S101, the CPU 24a makes the processing proceed to step S103.

In step S103, the CPU 24a waits until the user performs some operation on the confirmation message screen 400, that is to say, until the touch panel 22a accepts some operation as an answer from the user (NO in step S103). If the user performs some operation on the confirmation message screen 400, that is to say, if the touch panel 22a accepts some operation as an answer from the user (YES in step S103), the CPU 24a makes the processing proceed to step S105.

In step S105, the CPU 24a determines whether the operation, which has been performed by the user and accepted in step S103, is an operation instructing to conduct tilt correction, namely, an operation on the “YES” key 406. If the operation as performed by the user and accepted in step S103 is an operation on the “YES” key 406 (YES in step S105), the CPU 24a makes the processing proceed to step S17. If the operation as performed by the user and accepted in step S103 is not an operation on the “YES” key 406 but an operation on the “NO” key 408 (NO in step S105), the CPU 24a makes the processing proceed to step S9.

Thus, according to the second embodiment, the tilt correction by image processing is conducted if the absolute value |θx| of the angle of tilt θx of the document 100 is not less than the first threshold θa but is less than the second threshold θb and, in addition to that, the “YES” key 406 on the confirmation message screen 400 is operated. The tilt correction by image processing is not conducted if the “NO” key 408 on the confirmation message screen 400 is operated, even if the absolute value |θx| of the angle of tilt θx of the document 100 is not less than the first threshold θa but is less than the second threshold θb. The second embodiment as described above makes it possible to choose whether to conduct or not the tilt correction by image processing according to the user's wish and, in consequence, make use of the multifunction peripheral 10 in line with the user's wish.

The CPU 24a, which performs the process in step S101 of the document read controlling task so as to display the confirmation message screen 400 including the preview image 410 on the display 22b, cooperates with the display 22b to constitute an example of an inquirer. The CPU 24a also cooperates with the display 22b to constitute an example of a preview image display. The “YES” key 406 and the “NO” key 408 on the confirmation message screen 400, strictly the touch panel 22a, which accepts an answer from a user through the “YES” key 406 and the “NO” key 408, is an example of an answer acceptor.

The confirmation message screen 400 illustrated in FIG. 10 is an example, including the design thereof. In other words, the confirmation message screen 400 differently designed from the confirmation message screen 400 illustrated in FIG. 10 may be displayed. In addition, the preview image 410 may be displayed on a screen other than the confirmation message screen 400.

Steps S101 through S105 of the document read controlling task are provided between steps S15 and S17, which is not limitative. Steps S101 through S105 may be provided between steps S17 and S19. In other words, the processes in steps S101 through S105 may sequentially be performed after the process in step S17 is performed. In that case, the processing is made to proceed to step S19 if the determination in step S105 results in “YES”. The processing is made to proceed to step S11 if the determination in step S105 results in “NO”.

Other Application Examples

The embodiments as described above are each a specific example of the present invention and do not limit the technical scope of the present invention. The present invention can be applied to a situation different from either of the situations in the above embodiments.

For instance, with respect to steps S17 and S19 of the document read controlling task (see FIG. 9), the order of sequence may be reversed. In other words, after the image reading process in step S15, the processing may be made to proceed to step S19 so as to subject the read image data to the tilt correcting process in step S19. After that, the processing may be made to proceed to step S17 so as to perform the image processing for output and thereby generate the image data for output as subjected to tilt correction in step S17.

The first threshold θa as above may not be a fixed value but may be changed appropriately to some condition, such as the size of the document 100. Specifically, the first threshold θa may be so changed as to decrease as the size of the document 100 is increased. The first threshold θa may also be so changed as to decrease as the width or the length of the document 100 is increased.

Similarly, the second threshold θb may be changed appropriately to some condition, such as the size of the document 100. In other words, the second threshold θb may be so changed as to decrease as the size of the document 100 is increased. The second threshold θb may also be so changed as to decrease as the width or the length of the document 100 is increased.

The degree of tilt of the document 100 is determined based on the angle of tilt θx of the document 100, which is not limitative. The degree of tilt of the document 100 may be determined based on the difference in position ΔLx or the difference in time ΔTx as above. In that case, a threshold (position threshold or time threshold) according to the difference in position ΔLx or the difference in time ΔTx is appropriately set instead of the first and second thresholds θa and θb.

In the above embodiments, description is made on the case, where the present invention is applied to the multifunction peripheral 10 as a sort of image forming apparatus, which is not limitative. The present invention is applicable to a document reading device capable of reading an image of the document 100 in the document moving reading mode and, furthermore, an image output apparatus, such as a copier exclusive to copying and an image scanner exclusive to image scanning, equipped with the document reading device.

Moreover, the present invention is provided not only in the form of a device or an apparatus, that is to say, a document reading device or an image output apparatus but the form of a program, namely a control program for a document reading device and the form of a method, namely a control method for a document reading device as well.

The present invention can also be provided in the form of a non-transitory computer readable recording medium, on which a control program for a document reading device is recorded. Examples of the recording medium include semiconductor media, such as a secure digital (SD) memory card and a universal serial bus (USB) memory, and disk media, such as a compact disc (CD) and a digital versatile disk (DVD). Apart from such portable recording media, a recording medium of a device incorporated type (built-in type), such as a ROM and a hard disk drive, is also available as the recording medium as specified above.

What is claimed is:

1. A document reading device comprising: a conveyer that conveys a document in sheet form along a conveyance path;
an image reader that reads an image of the document passing through an image reading position on the conveyance path midway through conveyance by the conveyer;
a degree of tilt detector that detects a degree of tilt of the document with respect to a basic posture upstream from the image reading position in a conveyance direction of the document;
a tilt corrector that performs, based on a result of detection by the degree of tilt detector, a tilt correcting process for correcting a tilt of a read image read by the image reader;
a correction controller that makes the tilt correcting process to be performed by the tilt corrector unperformed if the result of detection by the degree of tilt detector is less than a first threshold, and causes the tilt corrector to perform the tilt correcting process if the result of detection by the degree of tilt detector is not less than the first threshold but is less than a second threshold larger than the first threshold; and
a stopper that stops conveyance of the document by the conveyer if the result of detection by the degree of tilt detector is not less than the second threshold.

2. The document reading device according to claim 1, further comprising: an inquirer that inquires of a user whether the user wishes the tilt correcting process performed, if the result of detection by the degree of tilt detector is not less than the first threshold but is less than the second threshold; and
an answer acceptor that accepts an answer offered by the user to an inquiry made by the inquirer,
wherein the correction controller causes the tilt corrector to perform the tilt correcting process if the result of detection by the degree of tilt detector is not less than the first threshold but is less than the second threshold and the answer offered by the user and accepted by the answer acceptor indicates that the user wishes the tilt correcting process performed.

3. The document reading device according to claim 2, further comprising a preview image display that displays a preview image based on the read image when the inquirer inquires of the user.

4. The document reading device according to claim 1, wherein the first threshold is optionally changeable.

5. An image output apparatus comprising: the document reading device according to claim 1; and
an image outputting device that outputs an image based on the read image.

6. A non-transitory computer readable recording medium storing a control program for a document reading device including a conveyer that conveys a document in sheet form along a conveyance path and an image reader that reads an image of the document passing through an image reading position on the conveyance path midway through conveyance by the conveyer, the control program causing a computer of the document reading device to implement:
a degree of tilt detecting procedure for detecting a degree of tilt of the document with respect to a basic posture upstream from the image reading position in a conveyance direction of the document;
a tilt correcting procedure for performing, based on a result of detection by the degree of tilt detecting procedure, a tilt correcting process for correcting a tilt of a read image read by the image reader;
a correction controlling procedure for making the tilt correcting process in the tilt correcting procedure unperformed if the result of detection by the degree of tilt detecting procedure is less than a first threshold, and causing the tilt correcting process in the tilt correcting procedure to be performed if the result of detection by the degree of tilt detecting procedure is not less than the first threshold but is less than a second threshold larger than the first threshold; and
a stopping procedure for stopping conveyance of the document by the conveyer if the result of detection by the degree of tilt detecting procedure is not less than the second threshold.

7. A control method for a document reading device including a conveyer that conveys a document in sheet form along a conveyance path and an image reader that reads an image of the document passing through an image reading position on the conveyance path midway through conveyance by the conveyer, the control method comprising:
conducting degree of tilt detection to detect a degree of tilt of the document with respect to a basic posture upstream from the image reading position in a conveyance direction of the document;
conducting tilt correction to perform, based on a result of the degree of tilt detection, a tilt correcting process for correcting a tilt of a read image read by the image reader;
conducting correction control to make the tilt correcting process in the tilt correction unperformed if the result of the degree of tilt detection is less than a first threshold, and cause the tilt correcting process in the tilt correction to be performed if the result of the degree of tilt detection is not less than the first threshold but is less than a second threshold larger than the first threshold; and
stopping conveyance of the document by the conveyer if the result of the degree of tilt detection is not less than the second threshold.
